(19) United States
(12) Patent Application Publication
(10) Pub. No.: US 2012/0046387 A1
(43) Pub. Date: Feb. 23, 2012

(54) SLURRY FOR PREPARING BORON NITRIDE AGGREGATES OF SPHERICAL GEOMETRY AND APPLICATION THEREOF

(76) Inventors: Keng Te Chu, Taichung County (TW); Yen Hung Chiu, Taichung County (TW)

(21) Appl. No.: 13/176,083

(22) Filed: Jul. 5, 2011

(30) Foreign Application Priority Data
Aug. 19, 2010 (TW) 99127732

(51) Int. Cl. B29B 9/08; C08J 3/22; C04B 35/5835

(52) U.S. Cl. 523/351; 264/13; 501/96.4; 501/87; 501/92

(57) ABSTRACT

The present invention provides a slurry for preparing boron nitride aggregates of spherical geometry, comprising: 3 wt %˜25 wt % of boron nitride; 1 wt %˜25 wt % of a nano-ceramic material; and a solvent as a complement to 100 wt %. In comparison with conventional preparation methods, preparation of boron nitride aggregates of spherical geometry at relatively low temperature can be achieved by using the slurry. Therefore, the demands of energy conservation and low cost are fulfilled. Besides, the present invention also provides a method for preparing boron nitride aggregates of spherical geometry.

### BACKGROUND OF THE INVENTION

1. Field of the Invention

The present invention is related to a slurry for preparing boron nitride aggregates of spherical geometry, and more particularly to a slurry for preparing boron nitride aggregates of spherical geometry at relatively low temperature.

2. Description of the Related Art

Hexagonal boron nitride is an upstream product of high-temperature, cosmetic, polymer, electronics, and optoelectronics industries and is the key filler materials for various high-temperature protection, high-temperature lubrication, thermal conduction and dissipation, and so on. It can be used to manufacture high-temperature release agents, high-temperature lubricants, cosmetic additives, thermally conductive and dissipative additives, and interface materials used as thermally conductive films.

Although traditional hexagonal boron nitride in a platelet morphology has many excellent properties such as high thermal conductivity coefficient, insulating property, hydrophobicity, chemical stability, lubricity, and so on, its powders tend to agglomerate. Accordingly, when boron nitride as a filler is added in an amount of more than 30 wt %, when boron nitride as a filler is added in an amount of more than 30 wt %, the resulted slurry is too viscous to be further processed and the amount of boron nitride cannot be increased, and thereby the functions of the products thereof are also hard to be enhanced dramatically. Besides, when boron nitride in the form of powders is direct mixed with a solvent, the resulted mixture has a poor operability because of the extreme viscosity and many of the functions of the composite material are also restricted by the aggregated boron nitride. For overcoming the aforesaid drawbacks, material suppliers traditionally mix boron nitride in the form of powders with a solvent and grind the mixture until the desired diameter (e.g. <1 μm) of the powders is achieved, and then evaporate the solvent to obtain dried powders. The dried powders are further provided for users to be mixed with polymers. However, the method not only consumes a large amount of time but also increases cost. Compared with general fillers which are easily dispersed (such as Al₂O₃ or ZnO), hexagonal BN still has disadvantages of inconvenient use and poor dispersion; therefore, its applicability is limited.

Furthermore, in order to improve those drawbacks, many research groups devote to do research focusing on boron nitride to be sphered at present. In the tradition method, boron nitride aggregates of spherical geometry are prepared by adding organic metal acetates as binders. Nevertheless, the functions of boron nitride aggregates of spherical geometry are affected in said method since the organic metal acetates transform as a portion of boron nitride powders. In order to prevent the above situation occurrence, the organic metal acetates are further transformed as innocuous inorganic oxide ceramics; therefore, it is necessary to heat them at 15000° C. for more than one hour. As such, energy is consumed extremely and relatively high cost is also required. Moreover, boron nitride is easily oxidized under too high temperature, so heat treatment of boron nitride has to be carried out under a specific atmosphere in the traditional process for protecting boron nitride; therefore, the difficulty for manufacturing is enhanced dramatically.

Those drawbacks mentioned above result in reducing the applicability of boron nitride so it is an important issue to develop a novel method for improving the disadvantages of conventional preparation of sphered boron nitride to enhance the applicability thereof.

### SUMMARY OF THE INVENTION

In view of foregoing disadvantages, one object of the present invention is to develop a slurry for preparing boron nitride aggregates of spherical geometry. Boron nitride aggregates of spherical geometry can be prepared at a relatively low temperature by said slurry, so the demand of energy conservation and low cost can be fulfilled.

Another object of the present invention is to develop a method for preparing boron nitride aggregates of spherical geometry at relatively low temperature. In said method, the sintering temperature required is reduced by the addition of solid binder.

To achieve the above objects, the present invention provides a slurry for preparing boron nitride aggregates of spherical geometry, comprising: 3 wt %˜25 wt % of boron nitride; 1 wt %˜25 wt % of a nano-ceramic material; and a solvent as a complement to 100 wt %.

In a preferred embodiment, said nano-ceramic material is metal oxides, non-metal carbides, or metal nanoparticles. Said metal oxides are preferably zinc oxide, titanium dioxide, or aluminium oxide, and said non-metal carbides are preferably silicon carbide.

In a preferred embodiment, said solvent is water or alcohols.

The present invention also provides a method for preparing boron nitride aggregates of spherical geometry, comprising steps of: (a) providing boron nitride and a nano-ceramic material; (b) dispersing said boron nitride and said nano-ceramic material into a solvent to obtain a slurry; (c) adjusting pH value of said slurry; and (d) spray drying and sintering said slurry from said step (c) to obtain boron nitride aggregates of spherical geometry.

In a preferred embodiment, said nano-ceramic material is metal oxides, non-metal carbides, or metal nanoparticles. Said metal oxides are preferably zinc oxide, titanium dioxide, or aluminium oxide, and said non-metal carbides are preferably silicon carbide.

In a preferred embodiment, said pH value is adjusted to 4 to 8.

In a preferred embodiment, said method further comprises a step of ball milling after said step (c).

In a preferred embodiment, said method further comprises a step of adding a surfactant after said step of ball milling. Preferably, said surfactant is polyvinyl alcohol or ammonium polyacrylate.

In a preferred embodiment, said sintering is carried out at a temperature ranged from 350° C. to 1000° C., and more preferably from 500° C. to 900° C.

According to the present invention, nano-ceramic materials with low sintering temperature are mainly used to reduce the temperature of heat treatment required in the process for sphering boron nitride, and thereby the demand of energy conservation and low cost can be fulfilled. In addition, the temperature of heat treatment is no more than 1000° C. in accordance with the present invention, so we need not protect the boron nitride under a specific atmosphere; therefore, the difficulty for manufacturing is reduced.

### BRIEF DESCRIPTION OF THE DRAWINGS

FIG. 1A shows the macroscopic SEM image (100×) according to the BN—TiO₂ composite powders of the example 1 before being sintered.

FIG. 1B shows the macroscopic SEM image (600×) according to the BN—TiO₂ composite powders of the example 1 after being sintered (i.e. the boron nitride aggregates of spherical geometry of the present invention).

FIG. 2A shows the microscopic SEM image (2000×) according to the BN—TiO₂ composite powders of the example 1 before being sintered.

FIG. 2B shows the microscopic SEM image (1900×) according to the BN—TiO₂ composite powders of the example 1 after being sintered (i.e. the boron nitride aggregates of spherical geometry of the present invention).

FIG. 3A shows the macroscopic SEM image (300×) according to the BN—Al₂O₃ composite powders of the example 2 before being sintered.

FIG. 3B shows the macroscopic SEM image (1000×) according to the BN—Al₂O₃ composite powders of the example 2 after being sintered (i.e. the boron nitride aggregates of spherical geometry of the present invention).

FIG. 4A shows the microscopic SEM image (20000×) according to the BN—Al₂O₃ composite powders of the example 2 before being sintered.

FIG. 4B shows the microscopic SEM image (50000×) according to the BN—Al₂O₃ composite powders of the example 2 after being sintered (i.e. the boron nitride aggregates of spherical geometry of the present invention).

FIG. 5A shows the macroscopic SEM image (300×) according to the boron nitride aggregates of spherical geometry of the example 3.

FIG. 5B shows the microscopic SEM image (3000×) according to the boron nitride aggregates of spherical geometry of the example 3.

FIG. 5C shows the SEM image (50000×) of the surface of the boron nitride aggregates of spherical geometry in accordance with the example 3.

### DETAILED DESCRIPTION OF THE PRESENT INVENTION

The present invention provides a slurry for preparing boron nitride aggregates of spherical geometry at relatively low temperature. Boron nitride aggregates of spherical geometry can be prepared at a temperature of no more than 1000° C. by said slurry.

Specifically, the slurry for preparing boron nitride aggregates of spherical geometry provided by the present invention comprises 3 wt %˜25 wt % of boron nitride; 1 wt %˜25 wt % of a nano-ceramic material; and a solvent as a complement to 100 wt %.

The method for preparing boron nitride aggregates of spherical geometry of the present invention comprises steps of (a) providing boron nitride and a nano-ceramic material; (b) dispersing said boron nitride and said nano-ceramic material into a solvent to obtain a slurry; (c) adjusting pH value of said slurry; and (d) spray drying and sintering said slurry from said step (c) to obtain boron nitride aggregates of spherical geometry.

In the present invention, the nano-ceramic material is acted as a solid binder which includes, but not limited to, metal oxides (such as zinc oxide, titanium dioxide, or aluminium oxide), non-metal carbides (such as silicon carbide), or metal nanoparticles (such as Ni, Ti, Al, Cu, or the alloy thereof). In practice, the nano-ceramic material may be selected by the user in accordance with its function. For example, when boron nitride is used as an additive for cosmetic, titanium dioxide is selected as a nano-ceramic material. In this case, the sphered boron nitride possesses not only the original features but also the function of ultraviolet radiation resistant.

It is easily understood that no specific limitation is imposed on the solvent used in the present invention as long as the boron nitride and nano-ceramic material can be dispersed into it. The solvent includes, but not limited to, water or alcohols.

In the present invention, the pH value of the slurry is adjusted by a basic or acidic solution. Said basic solution is preferably NaOH or NH₃ aqueous solution and said acidic solution is preferably HCl aqueous solution. Preferably, the pH value of the slurry is adjusted to 4 to 8. In addition, the adjusted slurry can be treated by ball milling to break up the aggregated powders in the solvent, and thereby the boron nitride and nano-ceramic material are dispersed into the solvent more evenly. Further, a surfactant can be added into the ball milled slurry, and then the resulted slurry is spray dried and sintered. Said surfactant includes, but not limited to polyvinyl alcohol or ammonium polyacrylate.

The terms “spray drying” and “sintering” used herein are both known techniques in the art, so no particular recital is imposed on them. It is noted that the sintering temperature is reduced to 350° C. to 1000° C. by adding a nano-ceramic material acted as a solid binder in accordance with the present invention and thus, the cost and difficulty for manufacturing are improved.

The technical features of the present invention have already recited in the description of specification. Other materials and formulas belong to traditional knowledge in the art, and those skilled in the art can implement the present invention accordingly. The following examples are used to demonstrate the technical features and advantages of the present invention clearly.

### Example 1

### Preparation of Boron Nitride Aggregates-1 of Spherical Geometry

40 g of hexagonal boron nitride with a mean particle size of 4 μm and 60 g of nanoscale titanium dioxide (Tio₂) with a particle size distribution of 30˜50 nm were used as starting materials. The hexagonal boron nitride and TiO₂ were dispersed into deionized water (400 mL), and then the mixture was stirred well to obtain a slurry. Subsequently, the pH value of the slurry was adjusted to 4 by HCl and NaOH aqueous solution. The adjusted slurry was ball milled, and then 10 g of 2 wt % polyvinyl alcohol aqueous solution was added. After that, the slurry was spray dried by spray dryer (CNK-SDD-0100) to give BN—TiO₂ composite powders. The operative condition of spray drying was inlet temperature of 200° C., outlet temperature of 120° C., speed of 3000 rpm, and feed rate of 1.5 L/hr. Subsequently, the BN—TiO₂ composite powders were sintered at 800° C. to give the boron nitride aggregates-1 of spherical geometry of the present invention (90 g).

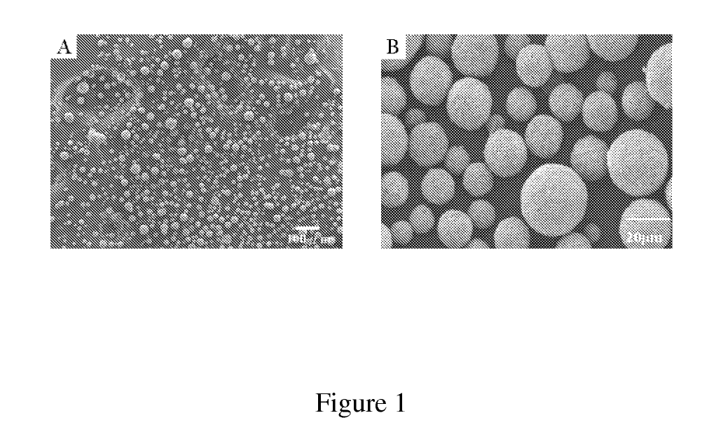

FIG. 1A shows the macroscopic SEM image (100×) of the BN—TiO₂ composite powders of the example 1 before being sintered. FIG. 1B shows the macroscopic SEM image (600×) of the BN—TiO₂ composite powders of the example 1 after being sintered (i.e. the macroscopic SEM image of the boron nitride aggregate-1s of spherical geometry of the present invention). As shown in FIG. 1B, the boron nitride aggregates of spherical geometry of the example 1 of the present invention has a particle size of 20˜50 μm.

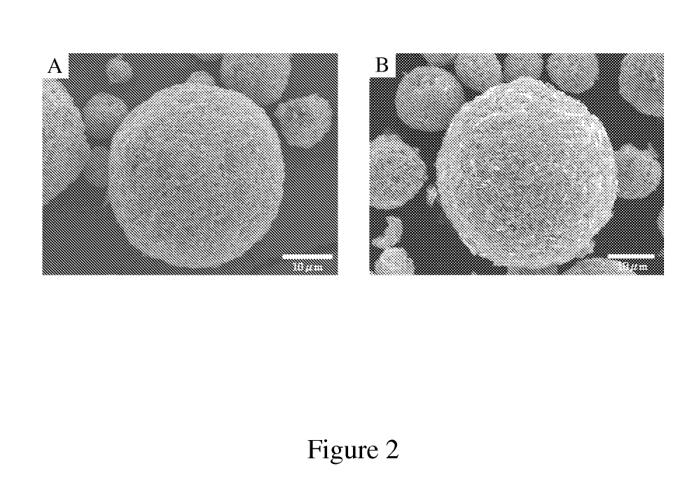

FIG. 2A shows the microscopic SEM image (2000×) of the BN—TiO₂ composite powders of the example 1 before being sintered. FIG. 2B shows the microscopic SEM image (1900×) of the BN—TiO₂ composite powders of the example 1 after being sintered (i.e. the microscopic SEM image of the boron nitride aggregates-1 of spherical geometry of the present invention). In accordance with FIG. 2A, the surface of un-sintered powders is wrapped with a thin film that is the surfactant. Besides, the result of FIG. 2B exhibits that the thin film disappears after the BN—TiO₂ composite powders are sintered, indicating that most of the surfactant was removed indeed. From above, the function of the boron nitride aggregates of spherical geometry according to the present invention is not affected since almost no surfactant is remained.

### Example 2

### Preparation of Boron Nitride Aggregates-2 of Spherical Geometry

The process for preparation of the BN—Al₂O₃ composite powders is the same as the BN—TiO₂ composite powders in the example 1 except that 45 g of hexagonal boron nitride and 45 g of nanoscale aluminium oxide (Al₂O₃) were used as starting materials. Subsequently, the BN—Al₂O₃ composite powders were sintered at 800° C. to give the boron nitride aggregates-2 of spherical geometry of the present invention (81 g).

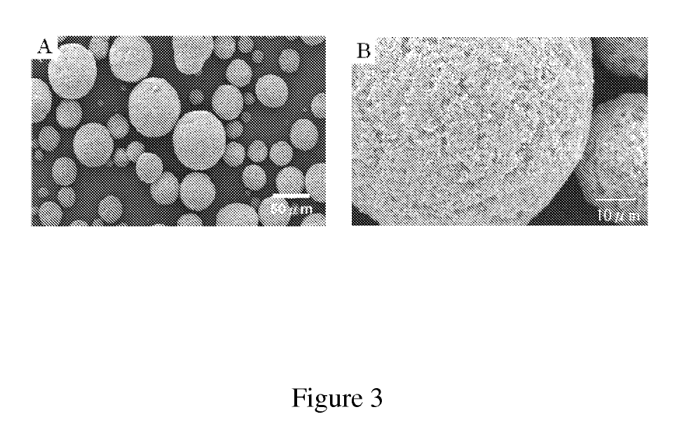

FIG. 3A shows the macroscopic SEM image (300×) of the BN—Al₂O₃ composite powders of the example 2 before being sintered. FIG. 3B shows the macroscopic SEM image (1000×) of the BN—Al₂O₃ composite powders of the example 2 after being sintered. As shown in FIG. 3B, the boron nitride aggregates of spherical geometry of the example 2 of the present invention has a particle size of 20˜80 μm and the spherical geometry is formed well.

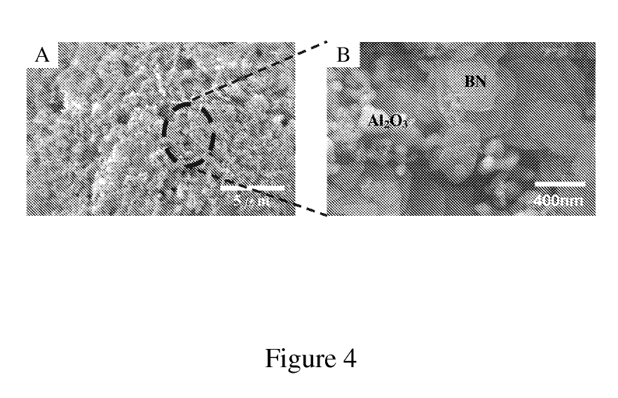

FIG. 4A shows the microscopic SEM image (20000×) of the BN—Al₂O₃ composite powders of the example 2 before being sintered. FIG. 4B shows the microscopic SEM image (50000×) of the BN—Al₂O₃ composite powders of the example 2 after being sintered (i.e. the enlarged SEM image of the circle region in FIG. 4A after being sintered), wherein the portion of granular morphology is Al₂O₃ and the portion of platelet morphology is boron nitride. As shown in FIG. 4B, most of surfactant was removed and Al₂O₃ was mutually sintered.

### Example 3

### Preparation of Boron Nitride Aggregates of Spherical Geometry-3

The process for preparation of the BN—Al₂O₃ composite powders is the same as the BN—TiO₂ composite powders in the example 1 except that 72 g of hexagonal boron nitride and 18 g of nanoscale aluminium oxide (Al₂O₃) were used as starting materials. Subsequently, the BN—Al₂O₃ composite powders were sintered at 800° C. to give the boron nitride aggregates-3 of spherical geometry of the present invention (81 g).

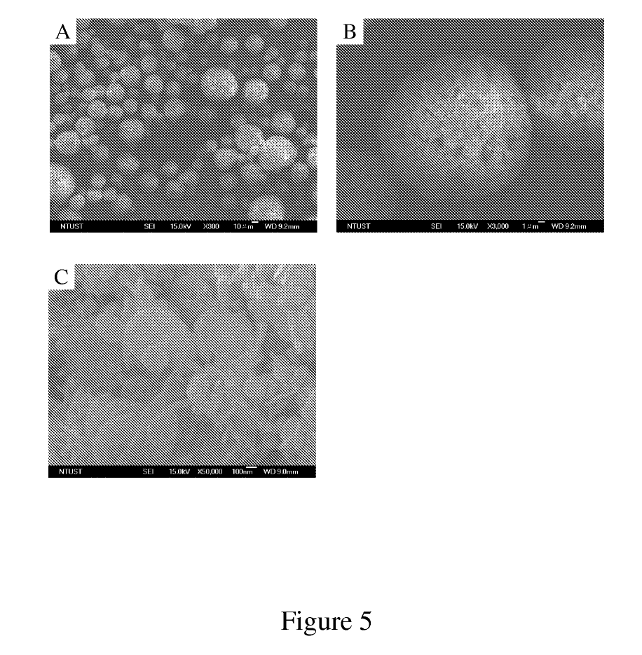

FIG. 5A shows the macroscopic SEM image (300×) of the boron nitride aggregates of spherical geometry of the example 3. FIG. 5B shows the microscopic SEM image (3000×) of the boron nitride aggregates of spherical geometry of the example 3. FIG. 5C shows the SEM image (50000×) the surface of the boron nitride aggregates of spherical geometry in accordance with the example 3. As shown in FIGS. 5A and 5B, the boron nitride aggregates of spherical geometry of the example 3 of the present invention has a particle size of 20˜80 μm and the spherical geometry is formed well. Also, according to FIG. 5C, the surface of the boron nitride aggregates of spherical geometry of the example 3 of the present invention is almost boron nitride and no Al₂O₃ is found.

To sum up, in comparison with the conventional method for preparing boron nitride aggregates of spherical geometry, the present invention has an advantage that the heat treatment is practiced at lower temperature, and thereby the energy consumption, the cost and difficulty for manufacturing are decreased. Moreover, because the residue amount of surfactant is less on the surface of the resulted boron nitride aggregates of spherical geometry, the function of the resulted boron nitride aggregates will not be affected, and thereby the applicability of boron nitride is enhanced dramatically.

### OTHER EMBODIMENTS

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features.

Furthermore, from the above description, one skilled in the art can easily ascertain the essential characteristics of the present invention, and without departing from the spirit and scope thereof, can make various changes and modifications of the invention to adapt it to various usages and conditions. Thus, other embodiments are also within the claims.

What is claimed is:

1. A slurry for preparing boron nitride aggregates of spherical geometry, comprising:
3 wt %˜25 wt % of boron nitride;
1 wt %˜25 wt % of a nano-ceramic material; and
a solvent as a complement to 100 wt %.

2. The slurry according to claim 1, wherein said nano-ceramic material is metal oxides, non-metal carbides, or metal nanoparticles.

3. The slurry according to claim 2, wherein said metal oxides are zinc oxide, titanium dioxide, or aluminium oxide.

4. The slurry according to claim 2, wherein said non-metal carbides are silicon carbide.

5. The slurry according to claim 1, wherein said solvent is water or alcohols.

6. A method for preparing boron nitride aggregates of spherical geometry, comprising steps of:
(a) providing boron nitride and a nano-ceramic material;
(b) dispersing said boron nitride and said nano-ceramic material into a solvent to obtain a slurry;
(c) adjusting pH value of said slurry; and
(d) spray drying and sintering said slurry from said step (c) to obtain boron nitride aggregates of spherical geometry.

7. The method according to claim 6, wherein said nano-ceramic material is metal oxides, non-metal carbides, or metal nanoparticles.

8. The method according to claim 7, wherein said metal oxides are zinc oxide, titanium dioxide, or aluminium oxide.

9. The method according to claim 7, wherein said non-metal carbides are silicon carbide.

10. The method according to claim 6, wherein said pH value is adjusted to 4 to 8.

11. The method according to claim 6, further comprising a step of ball milling after said step (c).

12. The method according to claim 11, further comprising a step of adding a surfactant after said step of ball milling.

13. The method according to claim 12, wherein said surfactant is polyvinyl alcohol or ammonium polyacrylate.

14. The method according to claim 6, wherein said sintering is carried out at a temperature ranged from 350° C. to 1000° C.
